(19) United States
(12) Patent Application Publication
(10) Pub. No.: US 2015/0074230 A1
(43) Pub. Date: Mar. 12, 2015

(54) High Efficiency Wireless File Transmission Method

(71) Applicant: InfoPower Corporation, Taipei (TW)

(72) Inventors: Che-Yu Lee, New Taipei City (TW); Chun-Lin Chen, Tainan City (TW)

(73) Assignee: InfoPower Corporation, Taipei (TW)

(21) Appl. No.: 14/022,253

(22) Filed: Sep. 10, 2013

(51) Int. Cl. H04L 29/08; G06F 3/0481; G06F 9/445

(52) U.S. Cl. CPC H04L 67/06; G06F 8/61; G06F 3/04817
USPC 709/219

(57) ABSTRACT

For transmitting a plurality of files from a personal computer to a portable electronic device via a server, a file transmission program is installed on a server and a portable electronic device in advance. The personal computer uses a web based accessing site to transmit files to the server. With the aid of the file transmission program, the files can be transmitted in an anonymous manner with the aid of an image code utilized for downloading a thumbnail to the portable electronic device indicating a path to the files on the server, or can be transmitted by using a same identity on the personal computer and the portable electronic device to link to the server.

### BACKGROUND OF THE INVENTION

1. Field of the Invention

The present invention relates to a file transmission method, and more particularly, a file transmission method for transmitting files from a personal computer to a portable electronic device.

2. Description of the Prior Art

There are a growing number of portable electronic devices that is available in the market. A single person may own several portable electronic devices at one time. Therefore there is a growing need by the consumer to transfer files between devices. This is especially apparent with regard to the need for synchronization of files between the personal computer of the user and his portable electronic device. In some cases, the user may also require access to files from other computers. At present, the file transfer is mostly done using a USB cable to establish a connection between the personal computer and the portable electronic device. In other cases file transfers are made by inserting an external memory from the portable device into the personal computer. However, these types of file transfer are inconvenient to the user and also time consuming. Therefore, there is a growing need for a high efficient wireless file transmission method.

### SUMMARY OF THE INVENTION

The present invention discloses a file transmission method. The method comprises installing and running a file transmission program on a server and a portable electronic device; uploading a plurality of files from the personal computer onto the server using a web based accessing site; generating an image code and a thumbnail by the server using the file transmission program according to the plurality of files, wherein the image code is utilized for downloading the thumbnail, and the thumbnail corresponds to a category of the plurality of files on the server; transmitting the image code from the server to the personal computer; displaying the image code on the personal computer; scanning the image code on the personal computer by the portable electronic device; using the file transmission program by the portable electronic device to decode the image code for downloading the thumbnail from the server; the portable electronic device using the thumbnail downloaded from the server to generate a path for downloading the plurality of files; the portable electronic device entering a command through the thumbnail and sending the command to the server to download at least one of the plurality of files; and downloading the at least one of the plurality of files from the server to the portable electronic device according to the path using the file transmission program.

The present invention also discloses a file transmission method. The method comprises installing and running a file transmission program on a server and a portable electronic device and accessing the server by a personal computer through a web based accessing site; registering a same identity for the personal computer and the portable electronic device on the server; uploading a plurality of files from the personal computer onto the server using the web based accessing site under the same identity; generating a thumbnail by the server using the file transmission program according to the plurality of files, wherein the thumbnail corresponds to a category of the plurality of files on the server; transmitting the thumbnail generated from the server to the portable electronic device under the same identity; the portable electronic device using the thumbnail downloaded from the server to generate a path for downloading the plurality of files; the portable electronic device entering a command through the thumbnail and sending the command to the server to download at least one of the plurality of files under the same identity; and downloading the at least one of the plurality of files from the server to the portable electronic device according to the path using the file transmission program under the same identity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 discloses a file transmission structure according to a first embodiment of the present invention.

FIG. 2 discloses a file transmission structure according to a second embodiment of the present invention.

FIG. 3 is a flowchart of the file transmission method implemented with the file transmission structure in FIG. 1.

FIG. 4 is a flowchart of the file transmission method implemented with the file transmission structure in FIG. 2.

### DETAILED DESCRIPTION

For enhancing file transmission between a personal computer and a portable electronic device, the present invention discloses some file transmission methods. In a first embodiment of the present invention, the disclosed file transmission method is utilized for enhancing anonymous file transmission, and in a second embodiment of the present invention, the disclosed file transmission method is utilized for enhancing file transmission under a same identity.

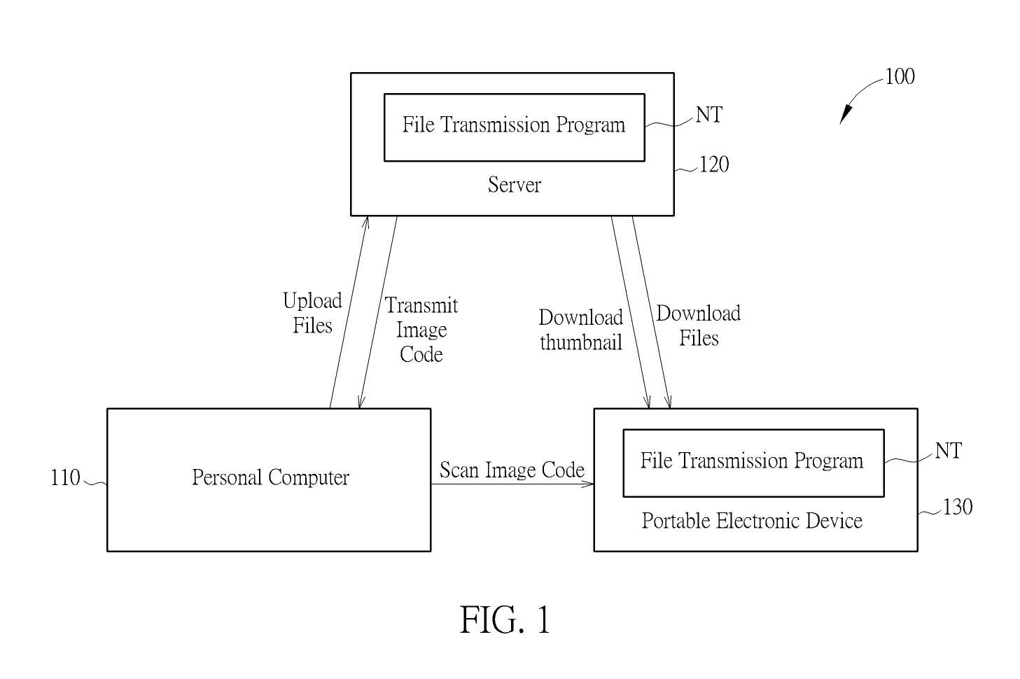

Please refer to FIG. 1. FIG. 1 shows file transmission structure 100 according to a first embodiment of the present invention. The disclosed file transmission structure 100 comprises a personal computer 110, a server 120 and a portable electronic device 130. The operation of the disclosed first embodiment of the present invention is supported by a file transmission program NT. The file transmission program NT is installed and run in the server 120 and the portable electronic device 130 in advance so that the following described operations related to FIG. 1 are supported. It is assumed that the user of the portable electronic device 130 has the intention of downloading a plurality of files from the personal computer 110. It is further assumed that the user has the intention to download the plurality of files anonymously to the portable electronic device 130.

The personal computer 110 shall upload the plurality of files to the server 120 through a web based accessing site. After the server 120 has received the plurality of files, it will generate an image code and a thumbnail. The image code is utilized for downloading the thumbnail and the thumbnail corresponds to a category of the plurality of files. The image code shall be transmitted to the personal computer 110 and displayed through the web based accessing site. The encoding scheme used to generate the image code may be a QR code and/or a watermark code. The user shall use the portable electronic device 130 to scan and decode the image code and identify and download the thumbnail. The file transmission program NT is capable of using a decoding scheme corresponding to the encoding scheme. The portable electronic device 130 shall download the thumbnail from the server 120. The thumbnail is displayed on the portable electronic device 130 to show the category of the plurality of files. The user may give a command through the thumbnail and send the command to the server 120 using the file transmission program NT for downloading at least one of the plurality of files from the server 120 to the portable electronic device 130.

As can be observed in the abovementioned descriptions related to FIG. 1, the mechanism shown in FIG. 1 does not require any registration of identities to the file transmission program NT run on the server 120 and the portable electronic device 130. The mechanism is performed in an anonymous manner so that it relieves the burden of registering a required identity to the file transmission program NT for accessing files on the personal computer 110, and file transfer from the personal computer 110 to the portable electronic device 130 is more convenient as a result.

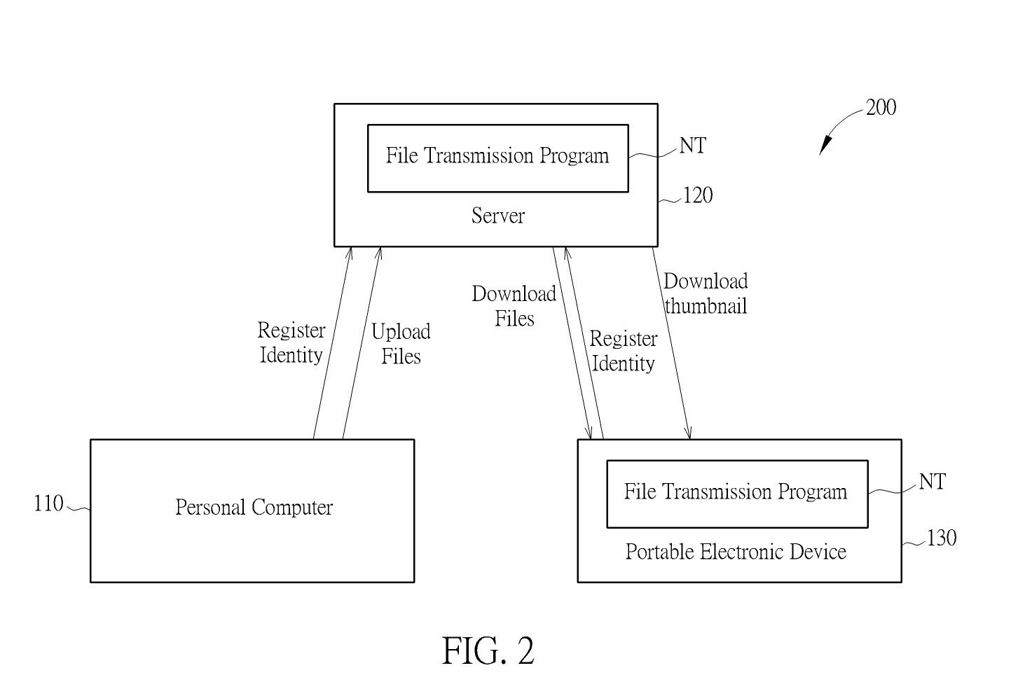

Please refer to FIG. 2. FIG. 2 shows a file transmission structure 200 according to the second embodiment of the present invention. Instead of utilizing an anonymous mechanism, the mechanism shown in FIG. 2 is performed by using a same identity that is registered to the file transmission program NT via the server 120. The same identity is simultaneously shared and used by the personal computer 110 and the portable electronic device 130. Similar with FIG. 1, the file transmission program NT is also run on the server 120 and the portable electronic device 130 in advance so that the following described operations related to FIG. 2 are supported.

First, the personal computer 110 shall upload a plurality of files onto the server 120 under the same identity through a web based accessing site. Second, the portable electronic device 130 is configured to download at least one of the plurality of files from the server 120 under the same identity as the personal computer 110.

Similarly as mentioned in the first embodiment of the present invention, a thumbnail is also generated to correspond to a category of the plurality of files by the server 120 and that the portable electronic device 130 is capable of displaying the thumbnail on the portable electronic device 130 using the file transmission program NT. The user may give a command through the thumbnail and send the command to the server 120 using the file transmission program NT for downloading at least one of the plurality of files from the server 120 to the portable electronic device 130.

The mechanism shown in FIG. 2 fulfills security requirements since the file transfer from the personal computer 110 to the portable electronic device 130 is performed under the same identity.

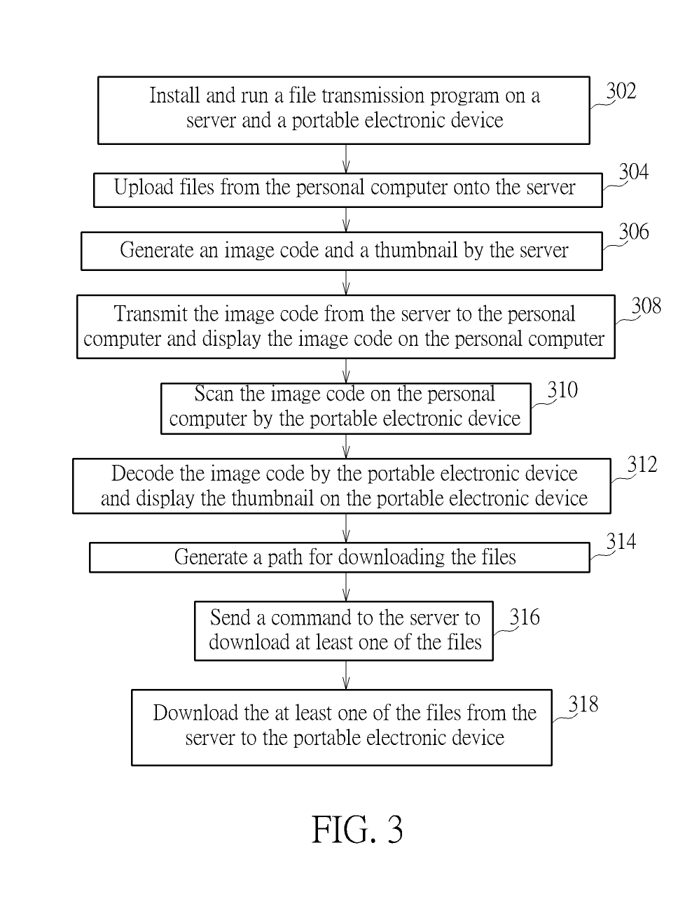

Please refer to FIG. 3, which is a flowchart of the file transmission method shown in FIG. 1 according to the first embodiment of the present invention. As shown in FIG. 3, the file transmission method includes the following steps:

Step 302: install and run the file transmission program NT on the server 120 and the portable electronic device 130;

Step 304: upload a plurality of files from the personal computer 110 onto the server 120 using a web based accessing site;

Step 306: generate an image code and a thumbnail by the server 120 using the file transmission program NT according to the plurality of files, wherein the image code is utilized for downloading the thumbnail, and the thumbnail corresponds to a category of the plurality of files on the server 120;

Step 308: transmit the image code from the server 120 to the personal computer 110 and display the image code on the personal computer 110;

Step 310: scan the image code on the personal computer 110 by the portable electronic device 130;

Step 312: use the file transmission program NT by the portable electronic device 130 to decode the image code for downloading the thumbnail from the server 120 and display the thumbnail on the portable electronic device 130;

Step 314: the portable electronic device 130 uses the thumbnail downloaded from the server 120 to generate a path for downloading the plurality of files;

Step 316: the portable electronic device 130 enters a command through the thumbnail and sends the command to the server 120 to download at least one of the plurality of files; and

Step 318: download the at least one of the plurality of files from the server 120 to the portable electronic device 130 according to the path using the file transmission program.

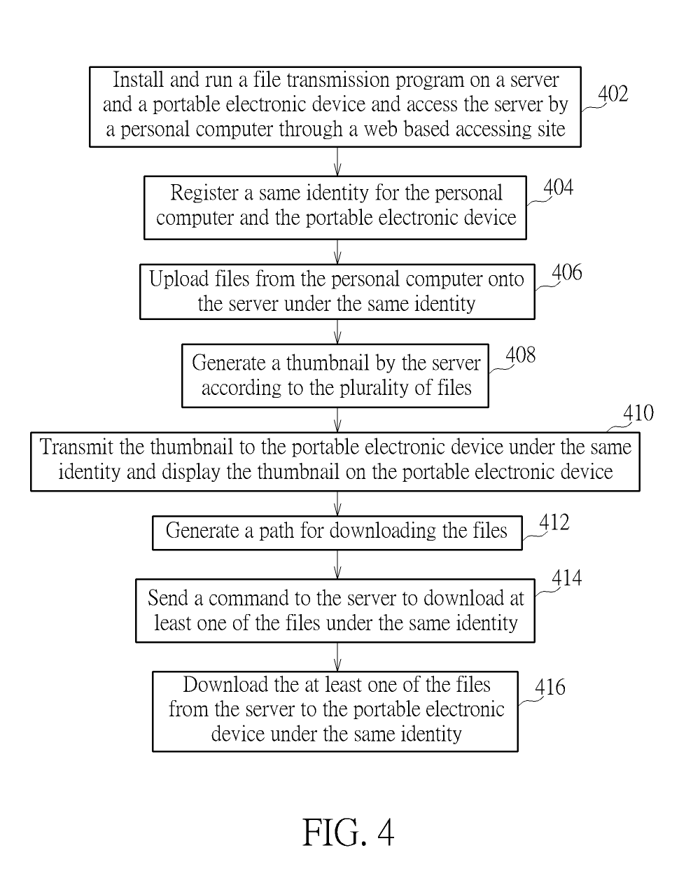

Please also refer to FIG. 4, which is a flowchart of the file transmission method shown in FIG. 2 according to the second embodiment of the present invention. As shown in FIG. 4, the file transmission method includes the following steps:

Step 402: install and run the file transmission program NT on the server 120 and the portable electronic device 130 and access the server 120 by the personal computer 110 through a web based accessing site;

Step 404: register a same identity for the personal computer 110 and the portable electronic device 130 on the server 120;

Step 406: upload a plurality of files from the personal computer 110 onto the server 120 using the web based accessing site under the same identity;

Step 408: generate a thumbnail by the server 120 using the file transmission program according to the plurality of files, wherein the thumbnail corresponds to a category of the plurality of files on the server 120;

Step 410: transmit the thumbnail generated from the server 120 to the portable electronic device 130 under the same identity and display the thumbnail on the portable electronic device 130;

Step 412: the portable electronic device 130 uses the thumbnail downloaded from the server 120 to generate a path for downloading the plurality of files;

Step 414: the portable electronic device 130 enters a command through the thumbnail and sends the command to the server 120 to download at least one of the plurality of files under the same identity; and

Step 416: download the at least one of the plurality of files from the server 120 to the portable electronic device 130 according to the path using the file transmission program under the same identity.

Note that embodiments formed by reasonable combination/permutation of and/or adding any limitation mentioned in this specification to the steps shown in FIG. 3 or FIG. 4 should also be regarded as embodiments of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A file transmission method, comprising:
installing and running a file transmission program on a server and a portable electronic device;
uploading a plurality of files from the personal computer onto the server using a web based accessing site;
generating an image code and a thumbnail by the server using the file transmission program according to the plurality of files, wherein the image code is utilized for downloading the thumbnail, and the thumbnail corresponds to a category of the plurality of files on the server;
transmitting the image code from the server to the personal computer;
displaying the image code on the personal computer;
scanning the image code on the personal computer by the portable electronic device;
using the file transmission program by the portable electronic device to decode the image code for downloading the thumbnail from the server;
the portable electronic device using the thumbnail downloaded from the server to generate a path for downloading the plurality of files;
the portable electronic device entering a command through the thumbnail and sending the command to the server to download at least one of the plurality of files; and
downloading the at least one of the plurality of files from the server to the portable electronic device according to the path using the file transmission program.

2. The method of claim 1, further comprising:
displaying the thumbnail on the portable electronic device.

3. The method of claim 1, wherein the image code generated is a QR code and/or a watermark code.

4. A file transmission method, comprising:
installing and running a file transmission program on a server and a portable electronic device and accessing the server by a personal computer through a web based accessing site;
registering a same identity for the personal computer and the portable electronic device on the server;
uploading a plurality of files from the personal computer onto the server using the web based accessing site under the same identity;
generating a thumbnail by the server using the file transmission program according to the plurality of files, wherein the thumbnail corresponds to a category of the plurality of files on the server;
transmitting the thumbnail generated from the server to the portable electronic device under the same identity;
the portable electronic device using the thumbnail downloaded from the server to generate a path for downloading the plurality of files;
the portable electronic device entering a command through the thumbnail and sending the command to the server to download at least one of the plurality of files under the same identity; and
downloading the at least one of the plurality of files from the server to the portable electronic device according to the path using the file transmission program under the same identity.

5. The method of claim 4, further comprising:
displaying the thumbnail on the portable electronic device.
